(19) United States
(12) Patent Application Publication
(10) Pub. No.: US 2020/0139748 A1
(43) Pub. Date: May 7, 2020

(54) Retractable hand lamp

(71) Applicant: Cuifang Yang, Tianjin City (CN)

(72) Inventor: Cuifang Yang, Tianjin City (CN)

(21) Appl. No.: 16/736,791

(22) Filed: Jan. 7, 2020

(30) Foreign Application Priority Data
Apr. 23, 2019 (CN) 2019103309325

(51) Int. Cl. B43M 99/00; F21V 33/00; G04F 1/06

(52) U.S. Cl. CPC B43M 99/001; F21W 2121/00; G04F 1/06; F21V 33/0048

(57) ABSTRACT

The invention discloses a bedroom desk decoration, which includes a bottom plate, and a decorative shell is fixedly mounted on the top end surface of the bottom plate. A rotation ring is mounted on the left end surface of the decorative shell to start a motor. The rotation of the second gear drives the first gears on the left and right sides to rotate in opposite directions to achieve the rotation of the spiral ornament to add decorative effects. The rotation of the fourth bevel gear drives the rotation of the fifth bevel gear, and the rotation of the fifth bevel gear drives the toggle. The slider can pull the pull wire to make the spring expression package jump up and down automatically. It can dynamically display various decorative accessories, improve the effect of decompression, and add pens. Pen holder reduces desktop space and improves desktop cleanliness.

### CROSS-REFERENCES TO RELATED APPLICATIONS

The present application claims priority from Chinese application No. 2019103537622 filed on Apr. 29, 2019 which is hereby incorporated by reference in its entirety.

### TECHNICAL FIELD

The invention relates to the field of desktop decoration articles, and in particular to a bedroom desk decoration.

### BACKGROUND OF THE INVENTION

People are prone to fatigue after studying or working on the desk for a long time. At present, the decorations on the desk desktop are usually static ornaments, which have a very small effect on solving short-term fatigue and decompression. Too much will make the desktop very cluttered and use less space.

### BRIEF SUMMARY OF THE INVENTION

An object of the present invention is to provide a bedroom desk decoration, which is used to overcome the above defects in the prior art.

According to an embodiment of the present invention, a bedroom desk decoration includes a bottom plate, and a decorative shell is fixedly installed on the top end surface of the bottom plate, and a rotating ring is mounted on the left end surface of the decorative case, and the rotating ring and the A decorative part is provided on the decorative case, the decorative part includes an hourglass fixedly installed in the rotating circle, elastic second electrode contacts are symmetrically provided on the top end surface of the bottom plate, and the front side of the decorative case A spring expression pack that can be decompressed is fixedly installed on the top end surface of the boss, a spiral ornament is fixed on the top end surface of the decorative case, a pen holder capable of holding a pen is provided on the front side of the decorative case, and the interior of the decorative case is A driving part capable of driving the rotation of the spiral ornament and the movement of the spring expression pack is provided. The driving part includes a first gear cavity provided in the decorative housing, and a first gear cavity is provided on the lower side of the first gear cavity. Two gear cavities, the first gear cavity and the top end surface of the decorative casing are symmetrically installed to rotate the rotation rod, and the top end surface of the rotation rod is fixedly installed with the spiral ornament A first gear is fixedly installed on the bottom end surface of the rotating rod, a first gear shaft is rotatably installed between the first gear cavity and the second gear cavity, and a second gear is fixedly installed on the top end surface of the first gear shaft, The second gear is provided with external teeth on the outer ring and internal teeth. The internal teeth on the second gear mesh with the first gear on the left, and the external teeth on the second gear and The first gear described on the right side is meshed to realize that when the second gear rotates, the rotation directions of the left and right spiral ornaments are opposite, and the driving component further includes a toggle cavity provided in the decorative housing. The rear side of the decorative shell is provided with a friction wheel cavity. A first friction wheel shaft is rotatably installed between the friction wheel cavity and the dial cavity. A dial wheel is fixedly installed on the front end surface of the first friction wheel shaft. A moving tooth is fixedly installed on the moving wheel, and a slider is slidably installed on the left inner wall of the moving cavity, and a pull line penetrating the top wall of the moving cavity is fixedly installed between the slider and the bottom wall of the spring expression pack. When the toggle gear slides down, make the cable pull The spring expression pack can jump up and down. The driving part is also provided with a control part that can control the power transmission of the spring expression pack that is automatically pulled. The control part includes a friction wheel provided on the rear side of the toggle cavity. Cavity, a third gear cavity is provided on the rear side of the friction wheel cavity, and a second friction wheel shaft is rotatably installed between the third gear cavity and the friction wheel cavity, and the front end of the second friction wheel shaft is spline-mounted A first friction wheel, which is rotatably mounted on a rear end surface of the first friction wheel, and can push the first friction wheel to a front and rear sliding sleeve on the second friction wheel shaft, the push sleeve and the friction wheel cavity A pull spring is fixedly installed between the rear inner walls, a second friction wheel is fixedly installed on the rear end surface of the first friction wheel shaft, a button groove is provided on the right side of the friction wheel cavity, and a button lever is slidingly installed in the button groove. The push rod is slidingly installed between the button rod and the friction wheel cavity, the push rod is slidingly installed with the push sleeve, the push rod is slidingly installed with the button rod, and when the button rod is pressed, the button rod is pushed First push rod The rubbing wheel causes the first friction wheel and the second friction wheel to frictionally cooperate with each other, and transmits power to the spring expression pack, so that the spring expression pack can jump up and down, and the pulling spring can control the power of the spring expression pack to be disconnected.

According to a further technical solution, the decorative component further includes a light slot provided on the rear end surface of the decorative shell with an opening rearward, a lighting lamp is fixedly installed in the light slot, and the hourglass is fixedly mounted with the decorative light symmetrically up and down.

In a further technical solution, the driving component further includes a motor fixedly installed in the left inner wall of the second gear cavity, an end face of the motor output shaft is fixedly connected to the motor shaft, and a first end is fixedly installed on the right end face of the motor shaft. A bevel gear, a second bevel gear is fixedly installed on the bottom end surface of the first gear shaft, the first bevel gear meshes with the second bevel gear, and a fourth bevel gear is fixedly installed on the left end surface of the motor shaft, the A fifth bevel gear is fixedly mounted on the rear end surface of the second friction wheel shaft, and the fifth bevel gear meshes with the fourth bevel gear.

The beneficial effect of the present invention is that the present invention can enable various decorative ornaments to be dynamically displayed, improve the effect of decompression, add a pen holder for pen writing, reduce the space occupation of the desktop, improve the cleanliness of the desktop, and is worth promoting.

### BRIEF DESCRIPTION OF THE DRAWINGS

FIG. 1 is a schematic diagram of the overall structure of the present invention;

FIG. 2 is a schematic rear view structure of FIG. 1;

FIG. 3 is a schematic cross-sectional view of the structure in the direction A-A in FIG. 1;

4 is a schematic cross-sectional view of the structure in the direction B-B in FIG. 3;

FIG. 5 is a schematic enlarged view of a position C in FIG. 3.

### DETAILED DESCRIPTION OF THE INVENTION

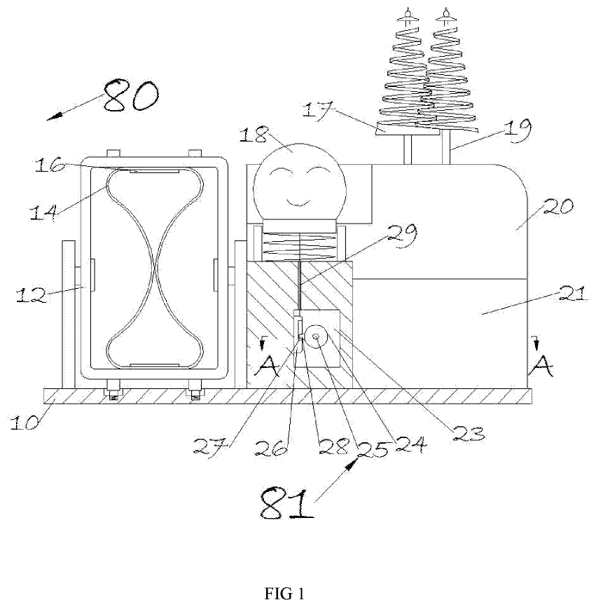

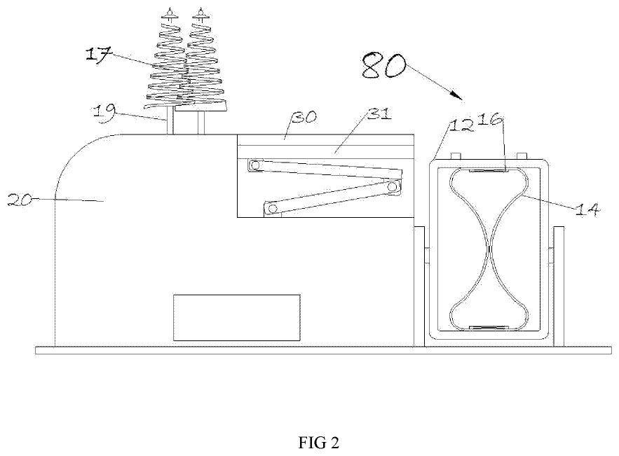

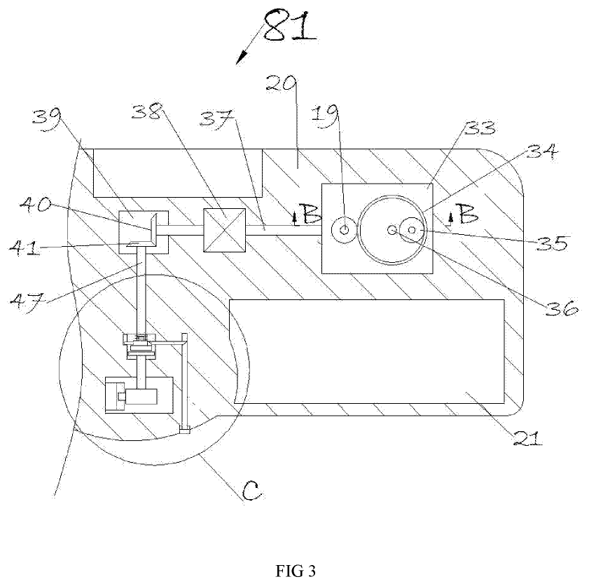

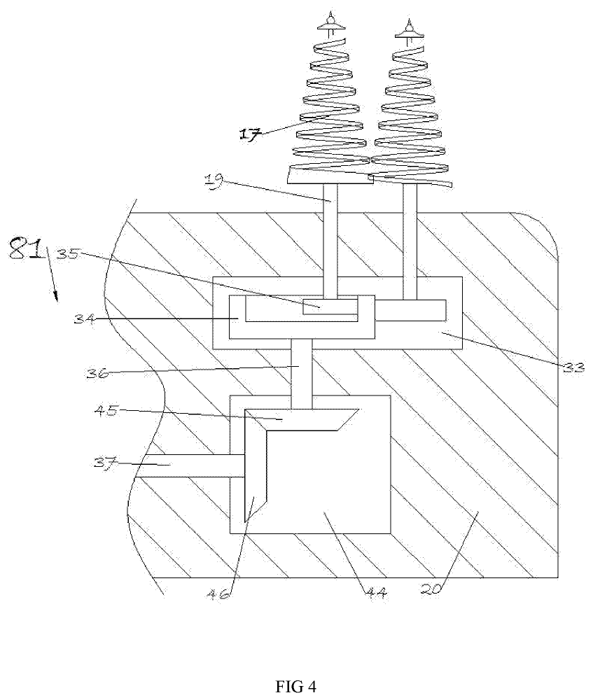

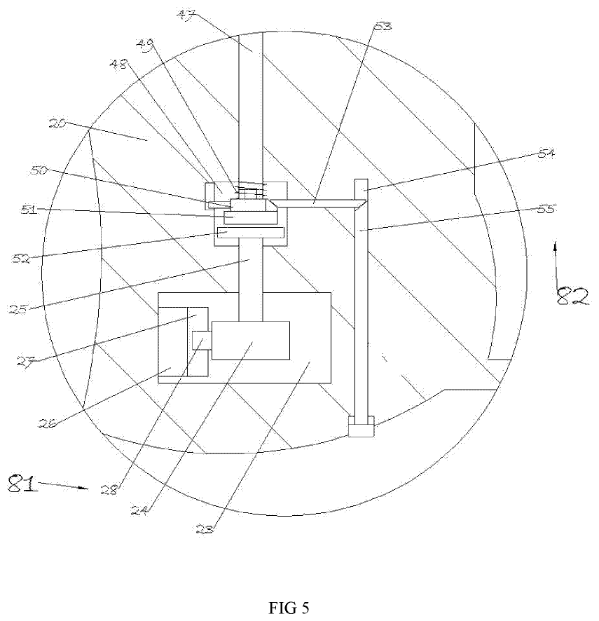

The present invention is described in detail below with reference to FIGS. 1-5. For convenience of description, the orientation described below is defined as follows: the up-down, left-right, front-back direction described below is consistent with the up-down, left-right, front-back direction of the projection relationship of FIG.

Referring to FIGS. 1-5, a bedroom desk decoration according to an embodiment of the present invention includes a bottom plate 10, and a decorative case 20 is fixedly installed on the top end surface of the bottom plate 10, and the left end surface of the decorative case 20 is rotatably installed. The rotating ring 12 is provided with a decorative member 80 on the rotating ring 12 and the decorative shell 20. The decorative member 80 includes an hourglass 14 fixedly installed in the rotating ring 12, and the left and right sides of the top end surface of the bottom plate 10 A resilient second electrode contact 43 is symmetrically provided, and a spring expression pack 18 capable of being decompressed is fixedly installed on the top end surface of the front boss of the decorative case 20, and a spiral ornament is fixed on the top end surface of the decorative case 20 17, a pen holder 21 capable of holding a pen is provided on the front side of the decorative case 20, and a driving member 81 is provided inside the decorative case 20 that can drive the spiral ornament 17 to rotate and the spring expression pack 18 to move,

The driving member 81 includes a first gear cavity 33 provided in the decoration case 20, and a second gear cavity 44 is provided below the first gear cavity 33. The first gear cavity 33 and the decoration A rotating rod 19 is symmetrically mounted on the top end surface of the housing 20, and the top end surface of the rotating rod 19 is fixedly installed with the spiral ornament 17, and a first gear 35 is fixed on the bottom end surface of the rotating rod 19. A first gear shaft 36 is rotatably mounted between a gear cavity 33 and the second gear cavity 44. A second gear 34 is fixedly mounted on the top end surface of the first gear shaft 36, and an outer ring of the second gear 34 is provided. External teeth with internal teeth. The internal teeth on the second gear 34 mesh internally with the first gear 35 on the left. The external teeth on the second gear 34 mesh with the first gear on the right. The gear 35 meshes so that when the second gear 34 rotates, the rotation directions of the left and right spiral ornaments 17 are opposite,

The driving member 81 further includes a dial cavity 23 provided in the decorative case 20. A friction wheel cavity 48 is provided on the rear side of the decorative case 20, and the friction wheel cavity 48 and the dial cavity 23 are provided. A first friction wheel shaft 25 is installed between the first friction wheel shaft 25, and a dial wheel 24 is fixedly installed on the front end surface of the first friction wheel shaft 25. The dial wheel 24 is fixed with a dial gear 28, and the dial cavity 23 is left A slider 26 is slidingly installed on the side inner wall, and a pull wire 29 penetrating the top wall of the toggle cavity 23 is fixedly installed between the slider 26 and the bottom wall of the spring expression package 18. When the toggle tooth 28 toggles the slider 26 When moving downward, the pull wire 29 pulls the spring expression pack 18, and the spring expression pack 18 can jump up and down to achieve the purpose of decompression.

The driving member 81 is further provided with a control member 82 that can control the power transmission of the automatic pull spring expression pack 18. The control member 82 includes a friction wheel cavity 48 provided on the rear side of the toggle cavity 23. A third gear cavity 39 is provided on the rear side of the wheel cavity 48, and a second friction wheel shaft 47 is rotatably installed between the third gear cavity 39 and the friction wheel cavity 48. The front end of the second friction wheel shaft 47 is splined. A first friction wheel 51 is installed, and the rear end surface of the first friction wheel 51 is rotatably mounted on the rear end surface of the first friction wheel 51. A pull spring 49 is fixedly installed between 50 and the inner wall on the rear side of the friction wheel cavity 48. A second friction wheel 52 is fixed on the rear end surface of the first friction wheel shaft 25. A button groove is provided on the right side of the friction wheel cavity 48. 54. A button lever 55 is slidably installed in the button groove 54, a push rod 53 is slidably installed between the button lever 55 and the friction wheel cavity 48, and the push rod 53 and the push sleeve 50 are slidingly installed. The push rod 53 is slidably installed with the button lever 55. When the button lever 55 is pressed, the push rod 55 is pushed 53 Push sleeve 50 The first friction wheel 51 causes the first friction wheel 51 and the second friction wheel 52 to frictionally cooperate with each other, transmitting power to the spring expression pack 18, so that the spring expression pack 18 can jump up and down, and the pulling spring 49 can control The power to pull the spring expression pack 18 is turned off.

The decorative component 80 further includes a rearward-facing light slot 30 provided on the rear end surface of the decorative case 20. A lighting lamp 31 is fixedly installed in the light slot 30, and the hourglass 14 is fixedly mounted with the decorative light symmetrically up and down. 16. Manually pressing the spring expression pack 18 can make the spring expression pack 18 jump up and down to achieve the purpose of decompression.

The driving member 81 further includes a motor 38 fixedly installed in the left inner wall of the second gear cavity 44. The end face of the output shaft of the motor 38 is fixedly connected to the motor shaft 37. A bevel gear 46, a second bevel gear 45 is fixedly installed on the bottom end surface of the first gear shaft 36, the first bevel gear 46 is meshed with the second bevel gear 45, and a left end surface of the motor shaft 37 is fixedly installed A fourth bevel gear 40, a fifth bevel gear 41 is fixedly mounted on the rear end surface of the second friction wheel shaft 47, and the fifth bevel gear 41 meshes with the fourth bevel gear 40, so that the motor 38 and the motor 38 can be started The fourth bevel gear 40 and the first bevel gear 46 are driven to rotate. The first bevel gear 46 is rotated to drive the second gear 34 to rotate. The second gear 34 is rotated to drive the first gears 35 on the left and right sides to rotate in opposite directions to realize the spiral. The decoration 17 is rotated to add a decorative effect. The rotation of the fourth bevel gear 40 drives the fifth bevel gear 41 to rotate. The rotation of the fifth bevel gear 41 drives the dial wheel 24 to rotate, and the rotation of the dial wheel 24 drives the dial tooth 28 to slide the slider. 26, the slider 26 can pull the cable 29 Expression spring package 18 can automatically jump up and down.

When in use: When the spring expression pack 18 is manually pressed, the spring expression pack 18 can jump up and down to achieve the purpose of decompression. When the motor 38 is started, the motor 38 drives the fourth bevel gear 40 and the first bevel gear 46 to rotate. The bevel gear 46 rotates to drive the second gear 34, and the second gear 34 rotates to drive the first gears 35 on the left and right sides to rotate in opposite directions, so that the spiral ornament 17 is rotated to add decorative effects, and the fourth bevel gear 40 is rotated to drive The fifth bevel gear 41 rotates, and the fifth bevel gear 41 rotates to drive the first friction wheel 51 to rotate. When the button lever 55 is pressed, the button lever 55 pushes the push sleeve 50 to match the first friction wheel 51 and the second friction wheel 52. The turning wheel 24 can be turned, and the turning wheel 24 can rotate the turning gear 28 to move the slider 26. The slider 26 can pull the pull wire 29 so that the spring expression pack 18 can automatically jump up and down. Pull the button lever 55 backward to make the first A friction wheel 51 and a second friction wheel 52 are no longer in contact, so that the power of the control motor is no longer transmitted to the spring expression pack 18, and the spring expression pack 18 does not automatically jump up and down due to the activation of the motor 38.

The beneficial effect of the present invention is that the present invention can enable various decorative ornaments to be dynamically displayed, improve the effect of decompression, add a pen holder for pen writing, reduce the space occupation of the desktop, improve the cleanliness of the desktop, and is worth promoting.

Those skilled in the art can clearly understand that various modifications to the above embodiments can be made without departing from the overall spirit and concept of the present invention. They all fall within the protection scope of the present invention. The protection scheme of the present invention is subject to the claims attached to the present invention.

1. A bedroom desk decoration, comprising a bottom plate, characterized in that: a decorative shell is fixedly mounted on the top end surface of the bottom plate, and a rotary ring is mounted on the left end surface of the decorative shell, and the rotary ring and the decoration The casing is provided with a decorative component, the decorative component includes an hourglass fixedly installed in the rotating circle, elastic second electrode contacts are symmetrically arranged on the top end surface of the bottom plate, and the front side of the decorative casing is convex A spring expression pack that can be decompressed is fixedly installed on the top end surface of the table. A spiral ornament is fixed on the top end surface of the decorative case. A pen holder capable of holding a pen is provided on the front side of the decorative case. There are driving parts that can drive the spiral ornament to rotate and the spring expression pack movement;
the driving component includes a first gear cavity provided in the decorative housing, a second gear cavity is provided on the lower side of the first gear cavity, and the left and right sides between the first gear cavity and the top end surface of the decorative housing A rotation rod is installed symmetrically, and the top end surface of the rotation rod is fixedly installed with the spiral ornament. A first gear is fixedly installed on the bottom end surface of the rotation rod, and the first gear cavity and the second gear cavity rotate. A first gear shaft is installed, and a second gear is fixedly installed on the top end surface of the first gear shaft. External gears are provided on the outer ring of the second gear, and internal teeth are provided on the internal surface of the second gear. The first gear described on the left meshes internally, and the external teeth on the second gear mesh with the first gear described on the right, so that when the second gear rotates, the left and right spiral ornaments rotate in opposite directions;
the driving component further includes a dial cavity provided in the decorative case, and a friction wheel cavity is provided on the rear side of the decorative case. A first friction wheel shaft is rotatably installed between the friction wheel cavity and the dial cavity. A dial wheel is fixedly installed on the front end surface of the first friction wheel shaft. Dial gears are fixedly installed on the dial wheel. A slider is slidably installed on the left inner wall of the dial cavity. A pull line penetrating through the top wall of the toggle cavity is fixedly installed between the bottom wall of the spring expression pack, and when the toggle teeth move the slider downward, the pull line pulls the spring expression pack to jump up and down;
the driving member is also provided with a control member that can control the power transmission of the automatic pulling spring expression pack. The control member includes a friction wheel cavity provided on the rear side of the toggle cavity. A third gear cavity, a second friction wheel shaft is rotatably installed between the third gear cavity and the friction wheel cavity, and the first friction wheel is splined on the front end of the second friction wheel shaft, and the first friction wheel A rotating sleeve is installed on the rear end surface to push the first friction wheel back and forth on the second friction wheel shaft. A push spring is fixedly installed between the push sleeve and the rear inner wall of the friction wheel cavity. A second friction wheel is fixedly mounted on the rear end surface of the first friction wheel shaft, and a button groove is provided on the right side of the friction wheel cavity. A button lever is slidably installed in the button groove, and the button lever and the friction wheel cavity The push rod is slidingly installed, and the push rod is slidingly installed with the push sleeve. The push rod is slidingly installed with the button rod. When the button rod is pressed, the first friction wheel of the push rod push sleeve pushes the first friction. The wheel and the second friction wheel rub against each other Together, the power transmitted to the spring package expression, expression of the spring package can jump up and down, the springs pull the pull spring may control the power OFF emotion package.

2. A bedroom desk decoration according to claim 1, wherein the decorative component further comprises a rearwardly opened light groove provided on the rear end surface of the decorative shell, and the light groove The lamp is fixedly installed, and the hourglass is fixedly installed with the decorative lamp symmetrically.

3. A bedroom desk decoration according to claim 1, wherein the driving component further comprises a motor fixedly installed in the left inner wall of the second gear cavity, and an end surface of the output shaft of the motor is fixedly connected. A motor shaft, a first bevel gear is fixedly installed on the right end face of the motor shaft, a second bevel gear is fixedly installed on the bottom end face of the first gear shaft, the first bevel gear meshes with the second bevel gear, and A fourth bevel gear is fixedly installed on the left end surface of the motor shaft, a fifth bevel gear is fixedly installed on the rear end surface of the second friction wheel shaft, and the fifth bevel gear meshes with the fourth bevel gear.
